(19) United States
(12) Patent Application Publication
(10) Pub. No.: US 2025/0290553 A1
(43) Pub. Date: Sep. 18, 2025

(54) ADJUSTABLE DAMPING VALVE DEVICE FOR A VIBRATION DAMPER

(71) Applicant: ZF Friedrichshafen AG, Friedrichshafen (DE)

(72) Inventors: Barbara ESTER, Schweinfurt (DE); Achim SAUERBREY, Schweinfurt (DE)

(21) Appl. No.: 19/075,060

(22) Filed: Mar. 10, 2025

(30) Foreign Application Priority Data
Mar. 18, 2024 (DE) 10 2024 202 488.0

(51) Int. Cl. F16F 9/46; F16F 9/18

(52) U.S. Cl. CPC F16F 9/465; F16F 9/18; F16F 2222/12; F16F 2228/066; F16F 2232/08; F16F 2234/02

(57) ABSTRACT

An adjustable damping valve device for a vibration damper comprises a damping valve housing in which a pilot stage valve for hydraulic control of a main stage valve is arranged. The damping valve housing is hydraulically connected to a working chamber on the piston rod side and a working chamber remote of the piston rod of a working cylinder of the vibration damper. The damping valve device has a check valve arrangement for the rectification of a control volume flow proceeding from the working chambers of the working cylinder to the pilot stage valve. A pilot stage valve body of the pilot stage valve has a first pressurized surface for an incident flow from the working chamber on the piston rod side and a second pressurized surface for an incident flow from the working chamber remote of the piston rod.

### BACKGROUND OF THE INVENTION

### 1. Field of the Invention

The disclosure is directed to an adjustable damping valve device for a vibration damper.

### 2. Description of Related Art

DE 44 18 972 A1 is directed to an adjustable damping valve device that comprises a valve housing at a piston rod of a vibration damper. The functional advantage of this damping valve device consists in the use of an individual pilot stage valve for an actuation of a main stage valve with an incident flow proceeding from a working chamber on the piston rod side and from a working chamber remote of the piston rod.

For this purpose, the damping valve device has a total of four check valves which provide for the rectification of a volume flow proceeding from the working chamber on the piston rod side and from the working chamber remote of the piston rod to the pilot stage valve and for the outflow from the rear chamber of the pilot stage valve to the two working chambers. The check valves switching the inflow are constructed at or in the main stage valve body.

The rectification of the volume flow for the pilot stage valve also entails an adaptation of the operating behavior of the entire damping valve device because the pilot stage valve also acts on a common main stage valve. Although pressurized surfaces of different size can be provided at the main stage valve for the two incident flow directions from the working chambers, the damping force ratio of pull direction to push direction that can be achieved in this way is not sufficient for some applications.

### SUMMARY OF THE INVENTION

It is an object of one aspect of the present invention to implement a damping valve device with a pilot stage valve that is active for both working directions of the vibration damper and in which the damping force ratio is to be more scalable during alternating incident flow at the damping valve device.

One aspect of the invention is a pilot stage valve body of the pilot stage valve having a first pressurized surface for an incident flow from the working chamber on the piston rod side and a second pressurized surface for an incident flow from the working chamber remote of the piston rod, and the pilot stage valve has a first control chamber for the first pressurized surface and a second control chamber for the second pressurized surface, the first control chamber and second control chamber being hydraulically separated.

By using two pressurized surfaces for different incident flow directions of the damping valve device, a large effect can be achieved with respect to the damping force characteristic in a comparatively small installation chamber. The achievable difference between the damping force level during an outward movement of the piston rod compared to the achievable damping force level during an inward movement of the piston rod into the working cylinder is appreciably larger than if only the pressurized surfaces at the main stage valve were utilized for this measure. The control chamber can also be a working chamber of the vibration damper.

The first pressurized surface and the second pressurized surface are loaded during an incident flow proceeding from one of the two working chambers, and only the first pressurized surface is loaded during an incident flow from the other of the two working chambers. The desired damping force difference can be still further increased by this measure.

The pilot stage valve body preferably has two functional portions which are movable relative to one another and which together radially limit the first pressurized surface at the pilot stage valve body. A substantial advantage of this constructional form consists in the simplified assembly and higher reliability of the pilot stage valve.

One functional portion is formed by a control plunger which has a control surface acted upon by pressure in the first control chamber. The control plunger can cooperate with a plate-shaped valve body, known per se, as second functional portion of the pilot stage valve.

In a further advantageous configuration, the control plunger has a second pressurized surface for the pilot stage valve which is acted upon by pressure in the second control chamber of the pilot stage valve. The second pressurized surface can be utilized, e.g., for the pressure in the control chamber to connect the two functional portions of the pilot stage valve with one another.

Alternatively, it can be provided that the radial extension of the first pressurized surface is determined via the relative axial position of the two functional portions with respect to one another. For example, if the second pressurized surface is oriented opposite the lift direction of the plate-shaped valve body as second functional portion, a distancing movement between the two functional portions can occur during a pressure load on the second pressurized surface, as a result of which the aforementioned radial extension of the first pressurized surface changes.

A particularly space-saving constructional form of the pilot stage valve is characterized in that a functional portion is axially movably guided inside of the main stage valve body.

With respect to the constructional implementation, it is advantageous when the functional portion which is axially movable inside of the main stage valve body penetrates the main stage valve body axially in pressing direction to one of the working chambers and has a surface which is acted upon by the pressure prevailing in this working chamber.

A preloading spring connects the two functional portions of the pilot stage valve body to one another for positioning the axially movable control plunger in a defined manner.

It can also be provided that the pilot stage valve has three control chambers, and at least two control chambers are acted upon by pressure in the lift direction of the pilot stage valve when the incident flow direction of the pilot stage valve proceeds from the working chambers. The third control chamber is used to provide a hydraulic force for both incident flow directions of the damping valve device, which hydraulic force moves the control plunger in direction of the plate-shaped valve body and connects the control plunger to the plate-shaped valve body.

With respect to simple flow paths inside of the damping valve device, it can also be provided that a control chamber for the main stage valve body is connected to two control chambers of the pilot stage valve.

To prevent a hydraulic short circuit via the pilot stage valve, a control chamber of the main stage valve and the second control chamber of the pilot stage valve are separated by a check valve which blocks a flow from the control chamber of the main stage valve to the second control chamber of the pilot stage valve.

### BRIEF DESCRIPTION OF THE DRAWINGS

The invention will be described in more detail referring to the following description of the drawings.

The drawings show:

FIG. 1 is a section through the damping valve device;

FIGS. 2-4 is a detail of the main stage valve body referring to FIG. 1 in different constructions;

FIG. 5 is an alternative construction referring to FIG. 1;

FIG. 6 is a detail referring to FIG. 4; and

FIG. 7 is a detail of the check valve arrangement downstream of the pilot stage valve according to FIGS. 1 and 5.

### DETAILED DESCRIPTION OF THE PRESENTLY PREFERRED EMBODIMENTS

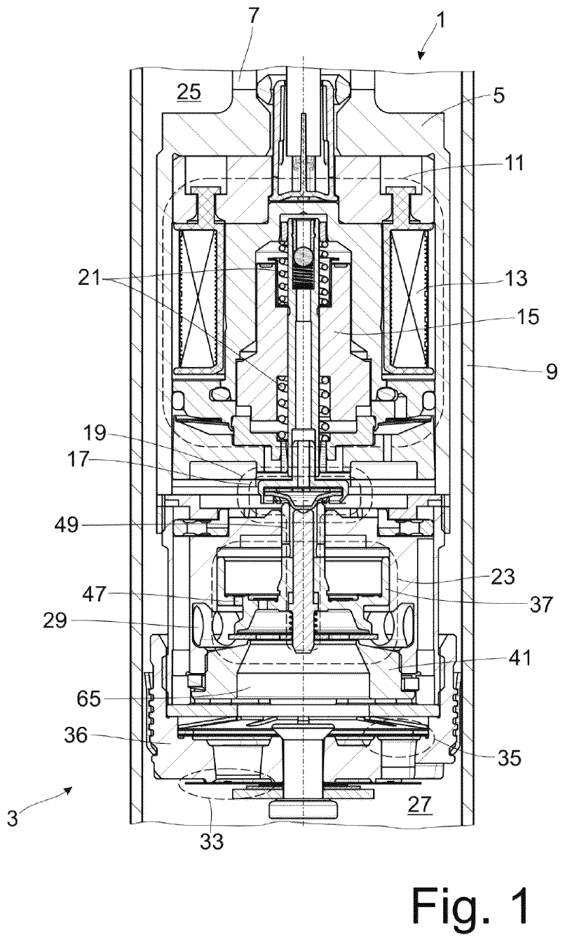

FIG. 1 shows a section through an adjustable damping valve device 1 for a vibration damper 3. In this example, the damping valve device 1 is shown in a damping valve housing 5 at an axially movable piston rod 7 inside of working cylinder 9 of the vibration damper 1. However, the damping valve housing 5 and therefore also the damping valve device 1 can also be arranged spatially external to the vibration damper 1 and, e.g., hydraulically connected via a pipe connection or hose connection.

The damping valve device 1 comprises an electromagnetic actuator 11 with a solenoid 13 and an armature 15 which acts at one end on a pilot stage valve body 17 of a pilot stage valve 19. The force of the solenoid 13 acts against at least one return spring 21.

The pilot stage valve 19 serves for the hydraulic actuation of a main stage valve 23 via which a working chamber 25 on the piston rod side and a working chamber 27 remote of the piston rod are connected to one another inside of the working cylinder 9. FIG. 1 shows radial connection channels 29 inside of a valve housing ring 31 as component part of the damping valve housing 5 which connect the working chamber 25 on the piston rod side to the main stage valve 23. A passive damping valve 33; 35 for a through-flow direction of the damping valve device 1, respectively, is arranged between the working chamber 27 remote of the piston rod and the main stage valve 23. The two passive damping valves 33; 35 are applied optionally. Regardless of the working direction of the piston rod 7 inside of the vibration damper 3, the volume flow of the damping medium located in the working cylinder 9 which determines the damping force is displaced via the connection channels 29, the main stage valve 23 and the two passive damping valves 33; 35. Otherwise, a sealed piston 36 as functional portion of the damping valve housing 5 provides for a spatial separation of the two working chambers 25; 27.

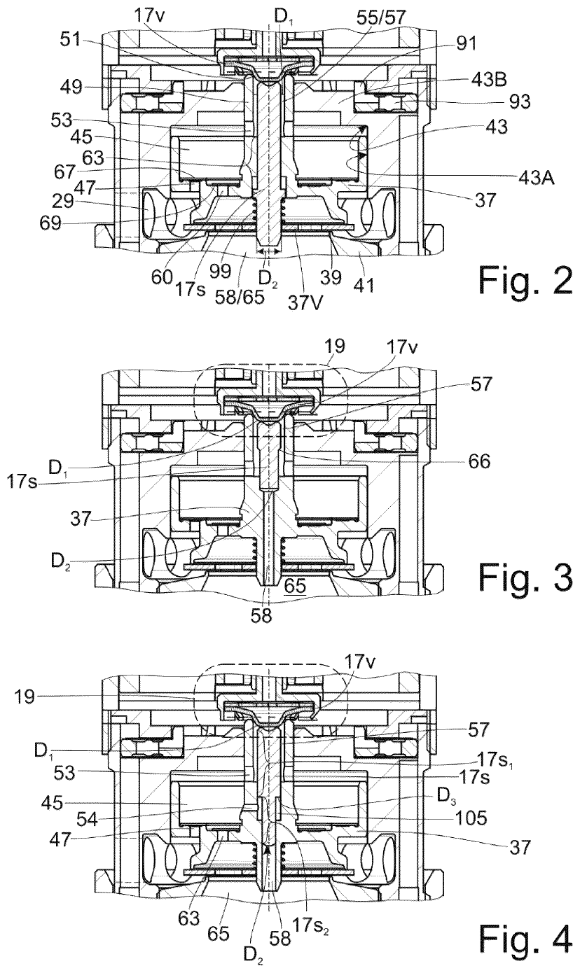

The main stage valve 23 comprises a main stage valve body 37 and a main stage valve seat surface 39 (see FIG. 2) which is formed by a valve ring 41 inside of the valve housing ring 31. The main stage valve body 37 is axially displaceably guided inside of a step opening 43 of the valve housing ring 31. The main stage valve body 37 is sealed relative to an inner lateral surface 43A of the step opening 43. The main stage valve body 37, a portion of the lateral surface 43A and a base 43B of the step opening 43 form a control chamber 45 for the main stage valve 23. This control chamber 45 is connected via at least a first choke channel 47 to the radial connection channels 29 and, depending on the choke function of the choke channel 47, there is a drop in pressure between the pressure in the connection channels 29 and the control chamber 45. The pressure in the control chamber 45 exerts a pressing force on the main stage valve body 37 which acts as closing force for the main stage valve 23.

The main stage valve body 37 has a valve pin 49 that faces in direction of the pilot stage valve 19 and has at the end thereof a pilot stage valve seat surface 51 for the plate-shaped pilot stage valve body 17. The valve pin 49 is hollow and has at least one radial port opening 53 to an axial channel in which the same pressure is present as in the first control chamber 45. It can also be provided that the port opening 53 exercises a choke function and there is therefore a pressure gradient between the control chamber 45 of the main stage valve body 37 and the axial channel.

The axial channel forms a second control chamber 55 for the main stage valve with a second closing force on the main stage valve body 23. The axial channel forms a first control chamber 57 for the pilot stage valve 19 with a pressing force component in lift direction of the pilot stage valve 19.

At least one connection channel 63 with a choke function similar to the first choke channel 47 extends inside of the main stage valve body 37 and connects a connection chamber 65 of the damping valve device 1 to the first control chamber 45. Accordingly, the connection chamber 65 is also connected to the first control chamber 57 of the pilot stage valve 19. To prevent a hydraulic short circuit via the first control chamber 45, the choke channel 47 and the connection channel 63 are outfitted with check valve disks 67; 69 opening in direction of the control chamber 45 of the main stage valve body 37.

In the present configuration of the damping valve device 1, the pilot stage valve body 17 has a first pressurized surface D₁ for an incident flow proceeding via the connection channels 29 and the choke channel 47. The first pressurized surface D₁ is limited at the edges by the pilot stage valve seat surface 51. The pilot stage valve body 17 comprises two functional portions which are movable and separable relative to one another, namely, the plate-shaped pilot stage valve body 17v which is supported on the pilot stage valve seat surface 51 and a control plunger 17s which completely penetrates the first control chamber 57 of the pilot stage valve 19 in pressing direction to the working chamber 27 remote of the piston rod, is guided inside of the main stage valve body 37 and extends into a second control chamber 58 of the pilot stage valve 19. The second control chamber 58 is identical in this case to the connection chamber 65 which is in turn a component part of the working chamber 27 remote of the piston rod. The effective cross section of the control plunger 17s defines an inner edge of the first pressurized surface D₁. The two control chambers 57; 58 of the pilot stage valve 19 are hydraulically separated by a dividing wall 60 of the valve housing ring 31, the control plunger 17s being axially movably guided inside of the dividing wall 60.

An end face of the control plunger 17s in the second control chamber 58 of the pilot stage valve 19 forms a second pressurized surface D₂ for the pilot stage valve 19, which second pressurized surface D₂ is only effective during an incident flow proceeding from the working chamber 27 remote of the piston rod.

A preloading spring 99 connects the two functional portions 17s; 17v of the pilot stage valve body 17 in that the preloading spring 99 is supported on a valve disk 37v of the main stage valve 23 and acts on a circumferential collar of the control plunger 17s.

During an incoming flow incident on the damping valve device 1 proceeding from the working chamber 27 remote of the piston rod, the damping medium passes the passive damping valve 35 and reaches the main stage valve 23 via the connection chamber 65. As has been described above, the connection chamber 65 constitutes the second control chamber 58, the pressure of which acts on the second pressurized surface D₂ of the pilot stage valve body 17 or control plunger 17s in lift direction.

A control volume flow flows via the connection channel 63 and the lifted check valve disk 69 into the first control chamber 45 and on into the second control chamber 55 of the main stage valve 23 or the first control chamber 57 of the pilot stage valve 19. The check valve disk 67 closes the choke channel 47 in direction of the port openings. In connection with the annular pressurized surface D₁, the pressure inside of the first control chamber 57 of the pilot stage valve 19 generates a further hydraulic lift force on the pilot stage valve body 17, particularly on the plate-shaped pilot stage valve body 17v.

With incoming flow to the damping valve device 1 proceeding from the working chamber on the piston rod side, the damping medium enters the valve housing 5 via the port openings to the main stage valve 23 and attains the first control chamber 45 of the main stage valve 23 via the choke channel 47 and the lifted check valve disk 67. Here also, the control volume flow flows via the at least one port opening 53 into the second control chamber of the main stage valve or the second control chamber 57 of the pilot stage valve 19, respectively. Accordingly, the pilot stage valve body 17 of the pilot stage valve 19 has only the first pressurized surface D1 for an incoming flow from the working chamber 25 on the piston rod side. For an incoming flow from the working chamber 27 remote of the piston rod, the pilot stage valve 19 has the second pressurized surface D2. The pilot stage valve 19 has the first control chamber 57 for the first pressurized surface D1 and the second control chamber 58 for the second pressurized surface D2, which are hydraulically separated, but the first pressurized surface D1 and second pressurized surface D2 are loaded during an incoming flow proceeding from the working chamber 27 remote of the piston rod. The appreciable difference in surface area in the pressurized surfaces, namely surface D₁, leads to an appreciably larger lifting force on the pilot stage valve 19 during an incident flow proceeding from the working chamber 27 on the piston rod side. This larger lifting force tends to open the pilot stage valve 19 more strongly at a low damping medium pressure inside of the working chamber 27 remote of the piston rod than at an identical pressure in the working chamber 25 on the piston rod side. Accordingly, the pressure in the first control chamber and second control chamber of the main stage valve is decreased, as a result of which the hydraulic closing force on the main stage valve body 37 is in turn reduced. Therefore, as an end result, the main stage valve 23 opens at a comparatively lower damping medium pressure in the working chamber 27 remote of the piston rod compared with an incident flow from the working chamber 25 on the piston rod side.

FIG. 3 shows an aspect of the invention in which the control plunger 17s does not extend beyond the main stage valve body 37 into the connection chamber 65, but rather the second control chamber 58 is constructed as an axial channel which extends from the connection chamber 65 to the end face D₂ of the control plunger 17s. In this example, the control chamber 58 is constructed as a step bore hole, and the step can form a supporting surface for the control plunger 17s. In contrast to the construction according to FIG. 2, the control plunger 17s has an annular control surface 66 which faces in direction of the plate-shaped pilot stage valve body 17v. This control surface 66 in conjunction with the pressure in the first control chamber 57 provides for a retaining force on the control plunger 17s for the permanent connection with the plate-shaped pilot stage valve body 17v. With an incident flow proceeding from the working chamber 25 on the piston rod side, the retaining force acts proceeding from the control surface 66. When the working chamber remote of the piston rod is compressed, the pressure on the second pressurized surface D₂ provides for the retaining force. The retaining forces may indeed vary in magnitude.

FIG. 4 discloses a further possibility for configuring the control chambers 57; 58 and the control plunger 17s with the aim of obtaining a hydraulic coupling between the two functional portions 17s; 17v of the pilot stage valve body 17. In this variant, the pilot stage valve 19 has three control chambers 57; 58; 105, and, with an incoming flow incident on the pilot stage valve 19 proceeding from the two working chambers 25; 27, at least two control chambers are acted upon by pressure in lift direction of the pilot stage valve 19. As in the construction according to FIG. 3, a step bore hole is present in the main stage valve body 37 but has two steps, one of which forms a boundary between two adjacent control chambers. The control plunger 17s has a simple step profile with a first longitudinal portion 17s₁ whose diameter is smaller than the diameter of the first control chamber 57.

The first longitudinal portion 17s₁ of the control plunger 17s extends into a third control chamber 105 which adjoins the first control chamber 57 in direction of the second control chamber 58.

The third control chamber 105 has a diameter which is adapted to the diameter of a first longitudinal portion 17s₁ of the control plunger 17s, and the first longitudinal portion 17s₁ is in register with the third control chamber 105 in every lift position of the control plunger 17s so that the wall of the third control chamber 105 forms a guide for the control plunger 17s. The second longitudinal portion 17s₂ of the control plunger 17s has the same diameter as the third control chamber 105 and extends within the second working chamber 58 and third working chamber 105.

The third control chamber 105 has a separate port opening 54 to the control chamber 45 of the main stage valve 23. The diameter of this port opening 54 can be selected, for example, appreciably smaller than the diameter of the port opening 53 between the first control chamber 57 of the pilot stage valve 19 and the control chamber 45 of the main stage valve 23.

With an incident flow on the pilot stage valve 19 proceeding from the working chamber 25 on the piston rod side via the choke channel 47 into the control chamber 45, the first control chamber 57 and the third control chamber 105 are supplied with a control volume flow and exert a lifting force on the plate-shaped pilot stage valve body 17v. The annular pressurized surface D₁ acts in the first control chamber and a likewise annular pressurized surface D₃ acts in the third control chamber. Surface D₃ is determined by the diameter of the third control chamber 105 which is smaller than the diameter D1 of the first control chamber. The control plunger 17s has, in the third control chamber 105, the same diameter D2 as in the second control chamber 58 which is spatially connected to the third control chamber 105. The size of the third pressurized surface D₃ is therefore determined by the diameter of the third control chamber 105 and the diameter of the first longitudinal portion 17s₁ of the control plunger 17s.

During an incident flow via the connection chamber 65 or the working chamber 27 remote of the piston rod, the surface D₂ at the control plunger is acted upon directly. A component of the control volume flows via the connection channel 63 into the control chamber 45 and on into the first control chamber 57 and third control chamber 105 so that a total of three control chambers 57; 58; 105 are then active, the sum of their lifting force being greater than the lifting force during an incident flow on the pilot stage valve 19 proceeding from the working chamber 25 on the piston rod side, and only the pressing force proceeding from the first control chamber 57 and third control chamber 105 of the pilot stage valve 19 are then active.

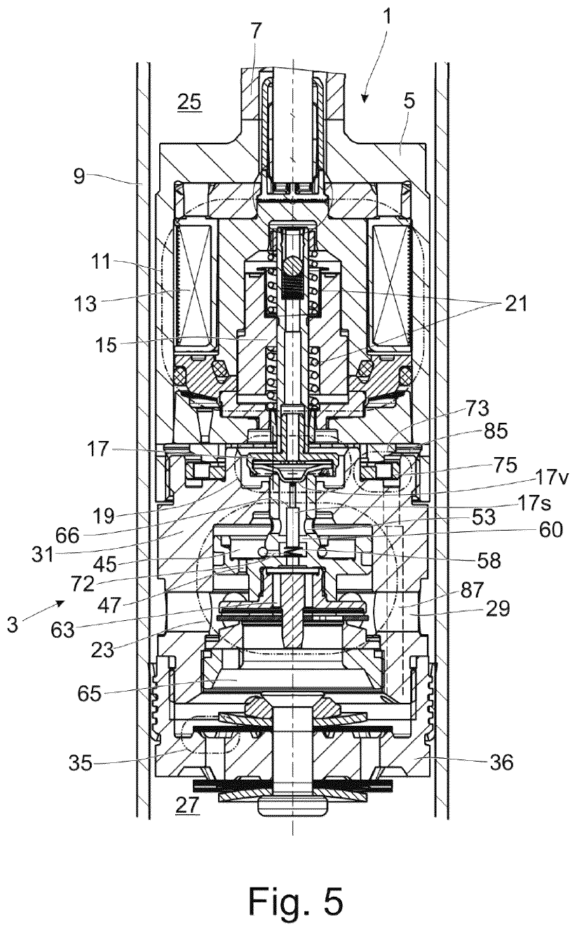

The configuration according to FIG. 5 shows a variant of the invention in which the two functional portions 17s; 17v of the pilot stage valve body 17 are mounted to be movable relative to one another at least in longitudinal direction. An elastomer coupling element 62 is provided between the two functional portions 17s; 17v and is axially preloaded by a tension spring 64, e.g., inside of the second control chamber 58, against the plate-shaped pilot stage valve body 17v. The cross section of a contact surface at the plate-shaped pilot stage valve body 17v is determined via the axial compression of the coupling element 62. The active pressurized surface D₁ inside of the first control chamber 57 is determined from the inner diameter of the pilot stage valve seat surface 51 minus the contact surface of the coupling element 62 at the plate-shaped pilot stage valve body 17 as has already been described in connection with the previous figures. Consequently, the radial extension of the first pressurized surface D₁ is determined by the relative axial position of the two functional portions 17s; 17v of the pilot stage valve body 17.

The control plunger 17s has within the first control chamber 57 of the pilot stage valve 19 a step profile with the annular control surface 66 which is loaded by pressure inside of the first control chamber 57 of the pilot stage valve 19 and moves the control plunger 17s against the force of the tension spring 64 in direction of the second control chamber 58 of the pilot stage valve 19.

The lifting of the pilot stage valve body 17 from the pilot stage valve seat surface 51 determines a choke cross section which in turn determines the pressure level in the first control chamber 45 and second control chamber 55 of the main stage valve. The pressures in the two control chambers 45; 55 multiplied by the axially pressurized surfaces at the main stage valve body gives a closing force operative on the main stage valve body 37 that determines the damping force of the vibration damper 3 in a given working movement of the vibration damper 3.

Irrespective of the configuration of the pilot stage valve with its control chambers and the control plunger, the damping medium displaced by the pilot stage valve 19 in all variants of the damping valve device reaches a rear chamber 71 of the pilot stage valve between the base 43B of the valve housing ring 31 and the actuator 11 which is connected to a check valve arrangement 73 that comprises a check valve ring 75 which is outfitted on both sides with at least one check valve disk 77; 79. The check valve ring 75 constitutes a component part which is separate from the valve housing ring 31 and exchangeable. The check valve disks 77; 79 on both sides in combination with the check valve ring 75 form two check valves 81; 83 for controlling the control volume outflow from the pilot stage valve 19 into the two working chambers 25; 27 of the working cylinder 9. In flow direction proceeding from the check valve arrangement 73 in direction of the working chamber 25 on the piston rod side, the damping valve housing 5 has at least one connecting opening 85 which, in this example, is a radial connecting opening 85. For connecting the pilot stage valve 19 to the working chamber 27 remote of the piston rod, the valve housing ring 31 has a channel system 87 which opens into the connection chamber 65. With an incident flow on the check valve arrangement 73 proceeding from one of the two working chambers 25; 27, the respective check valve 81; 83 on which the flow is directly incident, i.e., by circumventing the pilot stage valve 19, is closed.

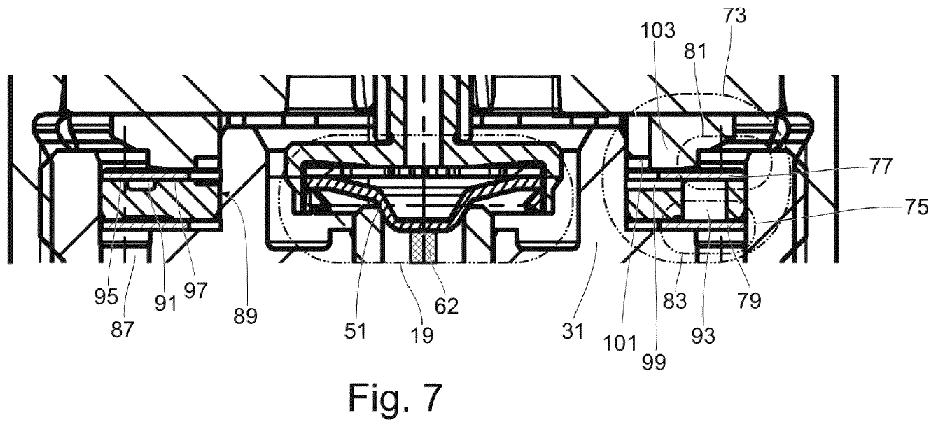

The check valve ring 75 is centered over its central through-opening 89 at the valve housing ring 31 and has a moat 91 in direction of the rear chamber 71 which in turn comprises axial port openings 93 to the channel system 87 in the valve housing ring 31. The moat 91 is radially bounded by two annular supporting surfaces 95; 97 for the check valve disk 77. An inner supporting surface 97 is interrupted by at least one radial channel 72 which connects the moat 91 to a radially inner connection channel 101. The connection channel 101 [ . . . ] the rear chamber 71 of the pilot stage valve 19 to the port openings 93 (FIG. 7).

The lifting movement of the check valve disk 79 for the channel system 87 in the valve housing ring 31 is limited by the valve housing ring 31. A cover ring 103 which additionally axially fixes the check valve ring 75 inside of the damping valve housing 5 provides for the lifting movement of the check valve disk 77 on the upper side of the check valve ring 75.

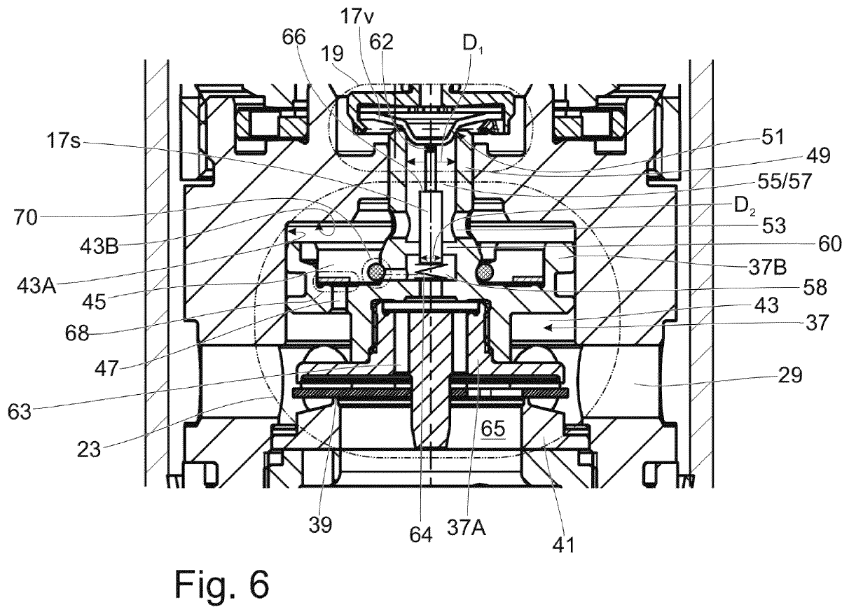

During an incident flow on the damping valve device 1 according to FIGS. 5 to 7 proceeding from a compression of the working chamber 27 remote of the piston rod, the damping medium passes the passive damping valve 35 and, inside of the connection chamber 65, provides for a pressurization of the main stage valve body 37 inside of a pressurization surface defined by the main stage valve seat surface 39. A control volume flow reaches the second control chamber 58 of the pilot stage valve 19 via the connection channel 63. At least one radial channel 72 connects the second control chamber 58 of the pilot stage valve 19 to the first control chamber 45 of the main stage valve 23. The check valve 70, which is formed, e.g., via a slightly preloaded O-ring at the valve pin 49 of the main stage valve body 37, is opened. The control volume flow continues the flow path via the at least one port opening 53 into the first annular control chamber 57 of the pilot stage valve 19. Accordingly, the first pressurized surface D₁ at the pilot stage valve body 17 and the second pressurized surface D₂ at the control plunger 17s are loaded in lift direction of the pilot stage valve 19.

A hydraulic closing force is also exerted on the main stage valve body 37 via the pressures in the two control chambers 45; 55. The control volume flow flows via the pilot stage valve 19 and the check valve disk 77 lifted from the check valve ring 75 through the connecting opening 85 into the working chamber 27 on the piston rod side.

The damping medium acting on the check valve 83 via the channel system 87 in the valve housing ring 31 closes this check valve 83. The check valve 68 of the main stage valve body 37 is also closed in this incident flow situation on the damping valve device 1.

During an incident flow at the damping valve device 1 proceeding from the working chamber 25 on the piston rod side, the displaced damping medium is present at an annular surface of the main stage valve body 37 that extends radially outwardly of the main stage valve seat surface 39 of the main stage valve 23 and extends inside the lateral surface 43A of the valve housing ring 31. This pressure force likewise causes a lifting force on the main stage valve body 37. Hydraulically parallel, the first control chamber 45 of the main stage valve 23 is also put under pressure via the first choke channel 47, whereupon a pressure increase also occurs in the second control chamber 55 of the main stage valve 23, which pressure increase together with the pressure increase in the first control chamber 45 causes a closing force on the main stage valve body 37.

The pressure in the control chamber 45 closes the check valve 70 to the second control chamber 58 of the pilot stage valve 19. Here, also, the control volume flow in the first control chamber 57 of the pilot stage valve exerts a lifting force on the plate-shaped pilot stage valve body 17v, but only on the annular first pressurized surface D₁. Accordingly, the first control chamber 57 of the pilot stage valve 19 is also hydraulically separated from the second control chamber 58 of the pilot stage valve 19. The control plunger 17s is loaded against the force of the tension spring 64 via the control surface 66 acted upon by the pressure in the first control chamber 57 of the pilot stage valve 19. Starting from a defined pressure level inside of the first control chamber 57 of the pilot stage valve 19, the control plunger 17s moves in direction of the second control chamber 58 of the pilot stage valve 19, as a result of which the compression of the elastomer coupling element 62 to the plate-shaped pilot stage valve body 17v decreases and, therefore, the cross section of the pressurized surface D₁ increases. This increase in surface area and, therefore, in force at the pilot stage valve body 17v can be utilized so that the pilot stage valve 19 tends to open more forcefully. If it is desirable to dispense with the pressure-dependent change in the size of the first pressurized surface D₁, the control plunger 17s can be used fixedly with the plate-shaped pilot stage valve body 17v and a control plunger without control surface 66.

The control volume flow flowing out through the pilot stage valve 19 into the rear chamber 71 then also reaches the connection channel 101, passes via the at least one radial channel into the moat 91 and can then flow out via the port openings 93 in combination with the channel system 87 into the connection chamber 65 and then on through the passive damping valve 33 into the working chamber 27 remote of the piston rod. Here also, the check valve 81 is closed in direction of the working chamber 25 on the piston rod side through the opposed incident flow from the working chamber 25 on the piston rod side so that a rectification of the control volume flow through the pilot stage valve 19 is achieved through the use of the total of four check valves 68; 70; 81; 83.

Thus, while there have shown and described and pointed out fundamental novel features of the invention as applied to a preferred aspect thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. An adjustable damping valve device for a vibration damper comprising:
a damping valve housing in which a pilot stage valve for hydraulic control of a main stage valve is arranged;
a working chamber on a piston rod side and a working chamber remote of the piston rod of a working cylinder of the vibration damper are each hydraulically connected to the damping valve housing;
a check valve arrangement of the damping valve device configured to rectify a control volume flow proceeding from the working chambers of the working cylinder to the pilot stage valve; and
a pilot stage valve body of the pilot stage valve has a first pressurized surface D₁ for an incident flow from the working chamber on the piston rod side and a second pressurized surface D₂ for an incident flow from the working chamber remote of the piston rod;
wherein the pilot stage valve has a first control chamber for the first pressurized surface D₁ and a second control chamber for the second pressurized surface D₂, the first control chamber and second control chamber being hydraulically separated.

2. The adjustable damping valve device according to claim 1, wherein the first pressurized surface D₁ and the second pressurized surface D₂ are loaded during an incident flow proceeding from one of the two working chambers, and only the first pressurized surface D₁ is loaded during an incident flow from the other of the two working chambers.

3. The adjustable damping valve device according to claim 1, wherein the pilot stage valve body has two functional portions which are movable relative to one another and which together radially limit the first pressurized surface D₁ at the pilot stage valve body.

4. The adjustable damping valve device according to claim 3, wherein one functional portion is formed by a control plunger which has a control surface acted upon by the pressure in the first control chamber.

5. The adjustable damping valve device according to claim 4, wherein the control plunger has a second pressurized surface D₂ for the pilot stage valve which is acted upon by pressure in the second control chamber of the pilot stage valve.

6. The adjustable damping valve device according to claim 3, wherein a radial extension of the first pressurized surface D₁ is determined via a relative axial position of the two functional portions with respect to one another.

7. The adjustable damping valve device according to claim 1, wherein a functional portion is axially movably guided inside of the main stage valve body.

8. The adjustable damping valve device according to claim 7, wherein the functional portion which is axially movable inside of the main stage valve body penetrates the main stage valve body axially in pressing direction to one of the working chambers and has a surface D₂ which is acted upon depending on a pressure prevailing in this working chamber.

9. The adjustable damping valve device according to claim 6, wherein a preloading spring connects the two functional portions of the pilot stage valve body to one another.

10. The adjustable damping valve device according to claim 1, wherein the pilot stage valve has three control chambers, wherein at least two control chambers are acted upon by pressure in a lift direction of the pilot stage valve when an incident flow direction of the pilot stage valve proceeds from the working chambers.

11. The adjustable damping valve device according to claim 10, wherein a control chamber for the main stage valve body is connected to two control chambers of the pilot stage valve.

12. The adjustable damping valve device according to claim 1, wherein the first control chamber of the main stage valve and the second control chamber of the pilot stage valve are separated by a check valve which blocks a flow from the first control chamber of the main stage valve to the second control chamber of the pilot stage valve.
